(19) United States
(12) Patent Application Publication
(10) Pub. No.: US 2010/0134927 A1
(43) Pub. Date: Jun. 3, 2010

(54) ACTUATOR STOPPER AND STORAGE APPARATUS

(75) Inventor: Hiroshi Minami, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/569,473

(22) Filed: Sep. 29, 2009

(30) Foreign Application Priority Data
Nov. 28, 2008 (JP) 2008-305232

(51) Int. Cl. G11B 5/55

(52) U.S. Cl. 360/265.1; G9B/5.182

(57) ABSTRACT

According to one embodiment, an actuator stopper contacts a butting portion of an actuator which moves a head in a movement direction in a movement plane, and restricts a movement range of the actuator along the movement direction. The actuator stopper includes a first portion and a second portion. The first portion is configured to be positioned at an upstream side along the movement direction and contact the butting portion of the actuator. The second portion is configured to be positioned at a downstream side along the movement direction, have a smaller height than the first portion along a direction vertical to the movement plane, and be formed integrally with the first portion.

### CROSS-REFERENCE TO RELATED APPLICATIONS

This application is based upon and claims the benefit of priority from Japanese Patent Application No. 2008-305232, filed on Nov. 28, 2008, the entire contents of which are incorporated herein by reference.

### BACKGROUND

1. Field

One embodiment of the invention relates to an actuator stopper and a storage apparatus, and more particularly, an actuator stopper that restricts a movement range of an actuator and a storage apparatus comprising the actuator stopper.

2. Description of the Related Art

Storage apparatuses that are represented by magnetic disk apparatuses have been required to improve a noise generated in the apparatus. For example, the noise that is generated in the magnetic disk apparatus comprises a noise that is generated when an actuator collides with an actuator stopper. The actuator stopper engages with a portion of the actuator to restrict a movement range of the actuator. The actuator stopper has the structure where a urethane rubber is attached to a pin formed in an aluminum base.

However, if the actuator collides with the actuator stopper at a relatively high speed, a loud collision sound may be generated, which may become one noise source of the noise generated in the magnetic disk apparatus. Accordingly, it is considered to form the actuator stopper using a relatively soft material (see, for example, Japanese Utility Model Application Publication (KOKAI) No. H5-50527 and Japanese Patent Application Publication (KOKAI) No. H9-231695).

Meanwhile, if the actuator stopper is formed of a relatively soft material, the actuator stopper deforms by a larger volume when the actuator collides with the actuator stopper. As a result, if a design of the magnetic disk apparatus, such as a component arrangement, is not changed, the actuator may collide with other components. If the design of the magnetic disk apparatus, such as the component arrangement, needs to be changed, this may cause a cost of the magnetic disk apparatus to increase. Since the relatively soft material is not used in other components of the magnetic disk apparatus, a material that is not used conventionally needs to be used as a dedicated material of the actuator stopper, which may result in increased cost of the magnetic disk apparatus.

In the conventional technology, it is difficult to decrease a noise generated when the actuator collides with the actuator stopper, without changing the design of the storage apparatus, such as the component arrangement, and increasing the cost of the storage apparatus.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of a storage apparatus according to an embodiment of the invention;

FIG. 2 is an exemplary plan view of the storage apparatus in the embodiment;

FIG. 3 is an exemplary plan view of the storage apparatus in the embodiment;

FIGS. 4A and 4B are exemplary views of a first example of a first actuator stopper;

FIG. 5 is an exemplary perspective view of the first example of the first actuator stopper;

FIGS. 6A and 6B are exemplary views of a second example of the first actuator stopper;

FIG. 7 is an exemplary perspective view of the second example of the first actuator stopper;

FIGS. 8A and 8B are exemplary views of a third example of the first actuator stopper;

FIG. 9 is an exemplary perspective view of the third example of the first actuator stopper;

FIGS. 10A and 10B are exemplary views of a first example of a second actuator stopper;

FIG. 11 is an exemplary perspective view of the first example of the second actuator stopper;

FIGS. 12A and 12B are exemplary views of a second example of the second actuator stopper;

FIG. 13 is an exemplary perspective view of the second example of the second actuator stopper;

FIGS. 14A and 14B are exemplary views of a third example of the second actuator stopper;

FIG. 15 is an exemplary perspective view of the third example of the second actuator stopper;

FIGS. 16A and 16B are exemplary views of a comparative example of the first actuator stopper;

FIGS. 17A and 17B are exemplary views of a comparative example of the second actuator stopper; and

FIG. 18 is an exemplary view of collision sounds of the actuator stopper according to the embodiment and the actuator stopper according to the comparative example.

### DETAILED DESCRIPTION

Various embodiments according to the invention will be described hereinafter with reference to the accompanying drawings. In general, according to one embodiment of the invention, an actuator stopper contacts a butting portion of an actuator which moves a head in a movement direction in a movement plane, and restricts a movement range of the actuator along the movement direction. The actuator stopper comprises: a first portion configured to be positioned at an upstream side along the movement direction and contact the butting portion of the actuator; and a second portion configured to be positioned at a downstream side along the movement direction, have a smaller height than the first portion along a direction vertical to the movement plane, and be formed integrally with the first portion.

According to another embodiment of the invention, a storage apparatus, comprises: a head configured to record information on or read information from a storage medium; an actuator configured to hold and move the head in a movement direction in a movement plane; and an actuator stopper configured to contact a butting portion of the actuator and restrict a movement range of the actuator along the movement direction. The actuator stopper comprises a first portion configured to be positioned at an upstream side along the movement direction and contact the butting portion of the actuator, and a second portion configured to be positioned at a downstream side along the movement direction, have a smaller height than the first portion along a direction vertical to the movement plane, and be formed integrally with the first portion.

In an actuator stopper and a storage apparatus that are disclosed herein, the actuator stopper that engages with a portion of an actuator to restrict a movement range of the actuator has an asymmetric shape. The height of the actuator stopper decreases toward a portion where the actuator stopper does not contact the actuator from a portion where the actuator stopper contacts the actuator. When the actuator collides with the side of the actuator stopper, a sound source of a collision sound is mainly a vibration of the sides of the actuator stopper. In general, a sound pressure is proportional to a volume velocity of the sound source. The volume velocity is a product of the vibration speed and a vibration area. In the disclosed actuator stopper, an area of the side surface of the actuator stopper is smaller than the conventional actuator stopper. Hence, the vibration area is small. In addition, since the actuator stopper has an asymmetrical shape, the height of the actuator stopper can be maintained, and a signal frequency of the actuator stopper at the time of collision with the actuator, that is, the vibration speed is not significantly different from that in the conventional actuator stopper. As a result, a noise that is generated when the actuator collides with the actuator stopper can be decreased.

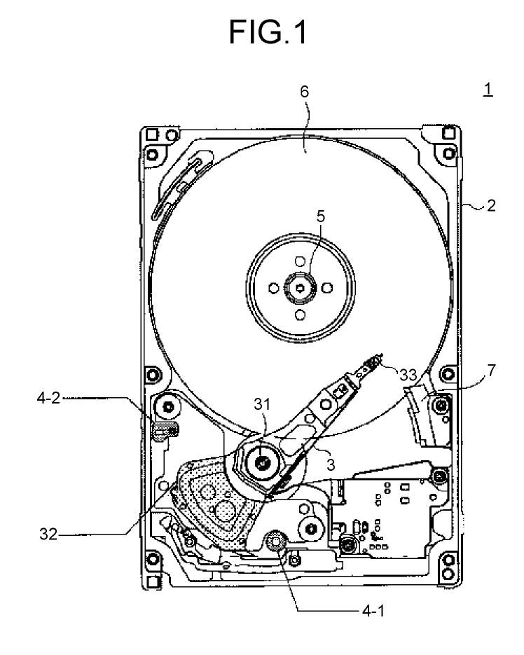

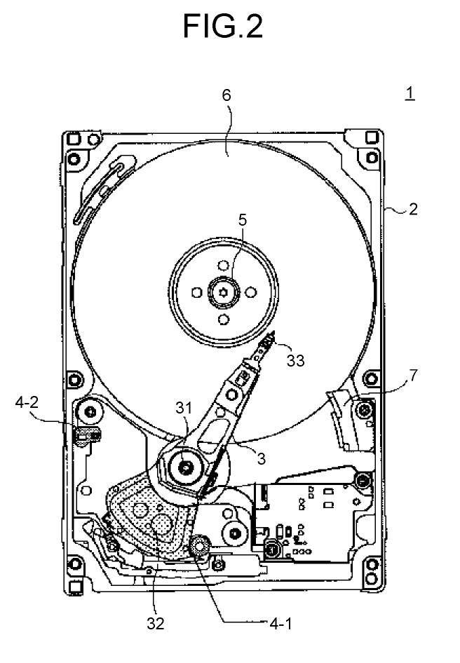

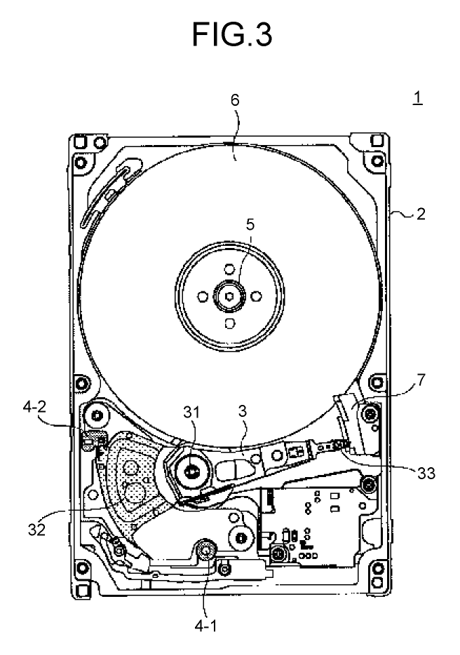

FIGS. 1 to 3 are plan views of a storage apparatus according to an embodiment of the invention. FIG. 1 illustrates a state where an actuator is disposed at an intermediate position of a movement range (or movable range). FIG. 2 illustrates a state where the actuator is disposed at a first limit position of the movement range. FIG. 3 illustrates a state where the actuator is disposed at a second limit position of the movement range. In this embodiment, the invention is applied to a magnetic disk apparatus.

In FIGS. 1 to 3, a magnetic disk apparatus 1 comprises an actuator 3, first and second actuator stoppers 4-1 and 4-2, a hub 5, a magnetic disk 6, and a ramp 7, which are provided in a housing 2. The actuator 3 is provided to rotate around a supporting point 31. A base of the actuator 3 is provided with a molding portion 32, and a front end thereof is provided with a head slider 33. The head slider 33 is provided with a recording head (not illustrated) to record information and a reproducing head (not illustrated) to reproduce information, in a state where the recording head and the reproducing head float from a surface of the magnetic disk 6 by a predetermined amount. When the actuator 3 rotates, a head of the head slider 33 is positioned at a desired position on the magnetic disk 6.

The front end of the actuator 3 is supported by the ramp 7 outside the magnetic disk 6, in a state where the actuator 3 is disposed at the second limit position of the movement range. The magnetic disk 6 is fixed on the hub 5 and rotates by a spindle motor (not illustrated). The number of each of the magnetic disk 5 and the actuator 3 is not limited in particular. The magnetic disk apparatus 1 is not limited to an apparatus of a ramp load/unload system where the head slider 33 is loaded from the ramp 7 to the magnetic disk 6 and is unloaded from the magnetic disk 6 to the ramp 7, and may be applied to an apparatus of a contact start-stop system.

As illustrated in FIG. 2, in a state where the actuator 3 is disposed at the first limit position of the movement range, the molding portion 32 contacts the first actuator stopper 4-1, and the rotation of the actuator 3 in a counterclockwise direction is regulated by the first actuator stopper 4-1. As illustrated in FIG. 3, in a state where the actuator 3 is disposed at the second limit position of the movement range, the molding portion 32 contacts the second actuator stopper 4-2, and the rotation of the actuator 3 in a clockwise direction is regulated by the second actuator stopper 4-2.

Since the configuration of the magnetic disk apparatus 1 other than the first and second actuator stoppers 4-1 and 4-2 is already known, the configuration of the magnetic disk apparatus 1 and the record reproducing operation are not described. It is needless to say that the configuration of the magnetic disk apparatus 1 is not limited to the configuration illustrated in FIGS. 1 to 3. The invention can be applied to any apparatus having the configuration where the movement range of the actuator 3 is restricted by the first and second actuator stoppers 4-1 and 4-2.

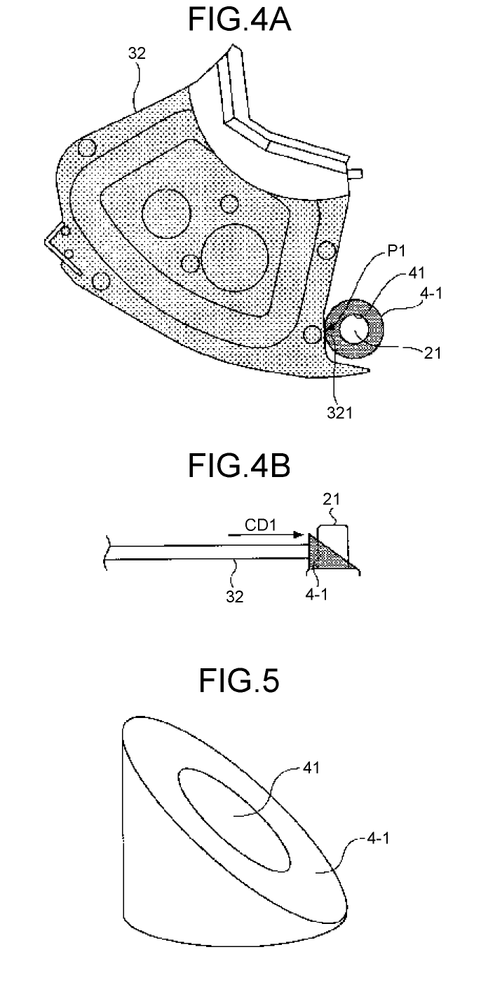

FIGS. 4A and 4B illustrate a first example of the first actuator stopper 4-1. FIGS. 4A and 4B are a plan view and a side view of a state where a first butting portion 321 provided in the molding portion 32 of the actuator 3 contacts the first actuator stopper 4-1, respectively. FIG. 5 is a perspective view of the first example of the first actuator stopper 4-1.

A central portion of the first actuator stopper 4-1 is provided with an opening 41. The first actuator stopper 4-1 is formed of a material having the same flexibility as the conventional actuator stopper. In the first actuator stopper 4-1, a pin 21 that is provided in the base formed on the bottom surface of the housing 2 or a base (not illustrated) provided in the housing 2 is mounted to be inserted into the opening 41. By appropriately selecting a diameter of the pin 21 and the opening 41, the first actuator stopper 4-1 is firmly attached to the pin 21. A material of the pin 21 and the first actuator stopper 4-1 is not limited in particular. However, the pin 21 may be formed of aluminum and the first actuator stopper 4-1 may be formed of urethane rubber.

As illustrated in FIGS. 4A to 5, the first actuator stopper 4-1 has a cylindrical shape (or tubular shape) in which a height is maximum at a first portion (or position) P1 contacting the first butting portion 321 and decreases toward a second portion not contacting the first butting portion 321. As can be seen from FIG. 4B, the first actuator stopper 4-1 has an upper taper (or inclined surface) whose height linearly decreases to approximately zero along a movement direction (counterclockwise direction in FIGS. 1 to 3) CD1 of the actuator 3. Accordingly, if the actuator 3 moves in the movement direction CD1, the first butting portion 321 collides with the portion P1 (having the maximum height) of the first actuator stopper 4-1, but a collision sound is decreased by the shape of the first actuator stopper 4-1. The height of the first actuator stopper 4-1 means a distance in a direction vertical to the movement plane of the actuator 3 (or rotation plane of the magnetic disk 6). Also, the height of the second actuator stopper 4-2 to be described in detail below means a distance, similar to the above case.

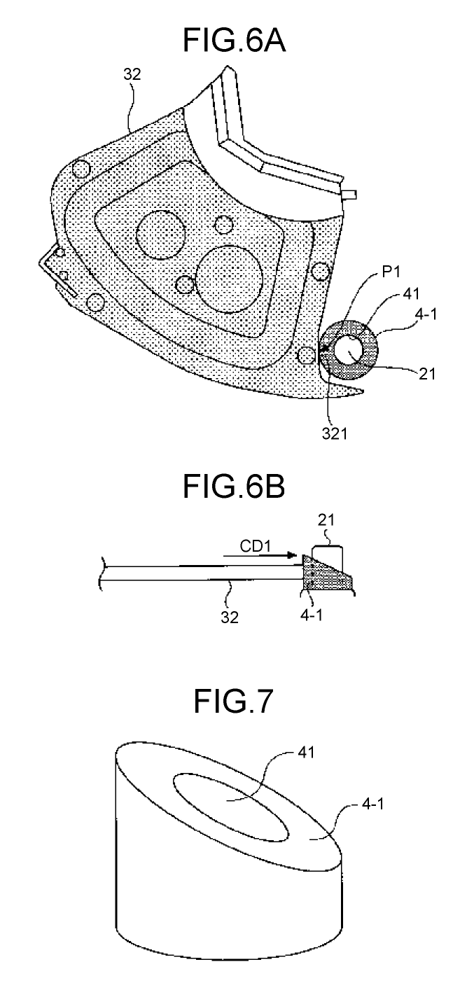

FIGS. 6A and 6B illustrate a second example of the first actuator stopper 4-1. FIGS. 6A and 6B are a plan view and a side view of a state where the first butting portion 321 provided in the molding portion 32 of the actuator 3 contacts the first actuator stopper 4-1, respectively. FIG. 7 is a perspective view of the second example of the first actuator stopper 4-1. In FIGS. 6A to 7, the same components as those in FIGS. 4A to 5 are denoted by the same reference numerals, and the repetitive description is omitted.

As illustrated in FIGS. 6A to 7, the first actuator stopper 4-1 has a cylindrical shape in which a height is maximum at a first portion (or position) P1 contacting the first butting portion 321 and decreases toward a second portion not contacting the first butting portion 321. As can be seen from FIG. 4B, the first actuator stopper 4-1 has an upper taper (or inclined surface) whose height linearly decreases to a predetermined height larger than zero along a movement direction (counterclockwise direction in FIGS. 1 to 3) CD1 of the actuator 3. Accordingly, if the actuator 3 moves in the movement direction CD1, the first butting portion 321 collides with the portion P1 (having the maximum height) of the first actuator stopper 4-1, but a collision sound is decreased by the shape of the first actuator stopper 4-1.

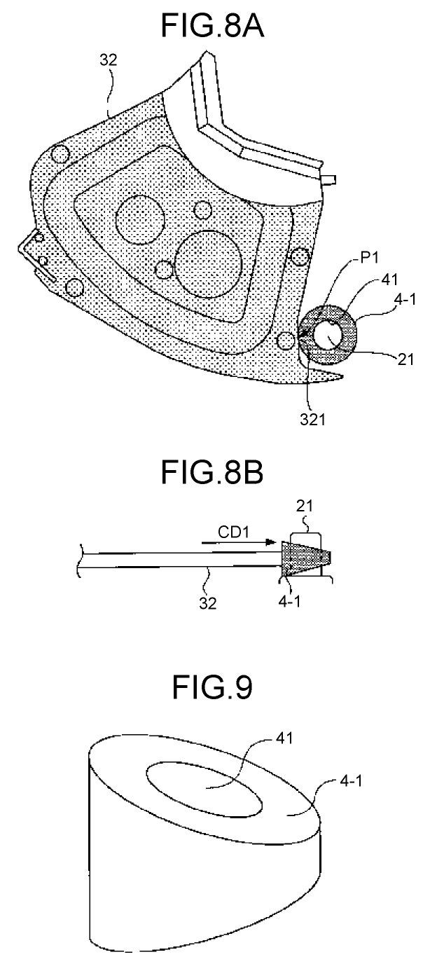

FIGS. 8A and 8B illustrate a third example of the first actuator stopper 4-1. FIGS. 8A and 8B are a plan view and a side view of a state where the first butting portion 321 provided in the molding portion 32 of the actuator 3 contacts the first actuator stopper 4-1, respectively. FIG. 9 is a perspective view of the third example of the first actuator stopper 4-1.

As illustrated in FIGS. 8A to 9, the first actuator stopper 4-1 has a cylindrical shape in which a height is maximum at a first portion (or position) P1 contacting the first butting portion 321 and decreases toward a second portion not contacting the first butting portion 321. As can be seen from FIG. 8B, the first actuator stopper 4-1 has upper and lower tapers (or inclined surfaces) whose heights linearly decrease along a movement direction (counterclockwise direction in FIGS. 1 to 3) CD1 of the actuator 3. The height of the first actuator stopper 4-1 may decrease to approximately zero along the movement direction CD1 or decrease to a predetermined height larger than zero. FIGS. 8A to 9 illustrate the case of the latter. Accordingly, if the actuator 3 moves in the movement direction CD1, the first butting portion 321 collides with the portion P1 (having the maximum height) of the first actuator stopper 4-1, but a collision sound is decreased by the shape of the first actuator stopper 4-1.

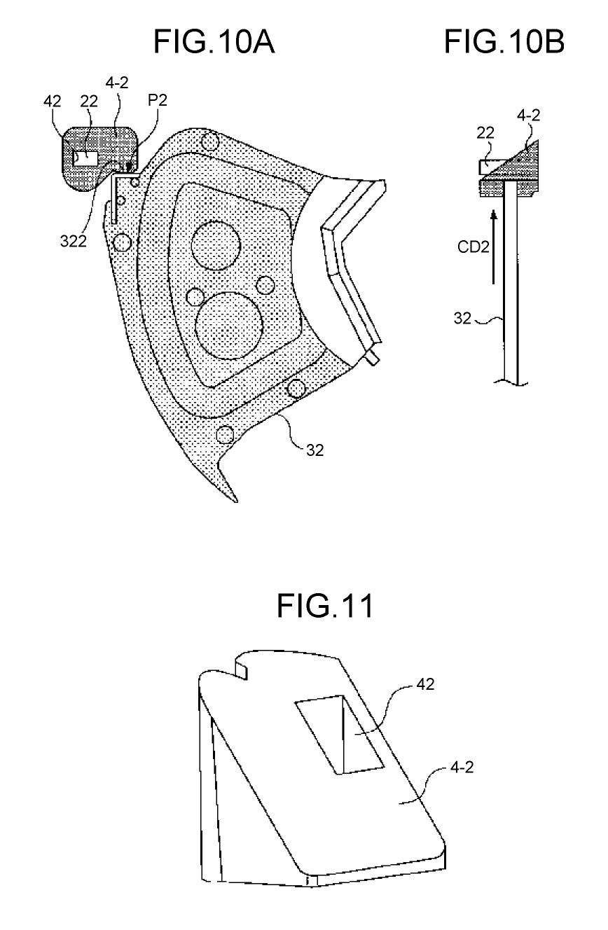

FIGS. 10A and 10B illustrate a first example of the second actuator stopper 4-2. FIGS. 10A and 10B are a plan view and a side view of a state where a second butting portion 322 provided in the molding portion 32 of the actuator 3 contacts the second actuator stopper 4-2, respectively. FIG. 11 is a perspective view of the first example of the second actuator stopper 4-2.

A central portion of the second actuator stopper 4-2 is provided with an opening 42. The second actuator stopper 4-2 is formed of a material having the same flexibility as the conventional actuator stopper. In the second actuator stopper 4-2, a pin 22 that is provided in the housing 2 or a base (not illustrated) provided in the housing 2 is mounted to be inserted into the opening 42. By appropriately selecting diameters of the pin 22 and the opening 42, the second actuator stopper 4-2 is firmly attached to the pin 22. A material of the pin 22 and the second actuator stopper 4-2 is not limited in particular. However, the pin 22 may be formed of aluminum and the second actuator stopper 4-2 may be formed of urethane rubber.

As illustrated in FIGS. 10A to 11, the second actuator stopper 4-2 has an approximately cylindrical shape (or hollow quadratic prism shape) in which a height is maximum at a first portion (or position) P2 contacting the second butting portion 322 and decreases toward a second portion not contacting the second butting portion 322. As can be seen from FIG. 10B, the second actuator stopper 4-2 has an upper taper whose height linearly decreases to approximately zero along a movement direction (clockwise direction in FIG. 1 to FIG. 3) CD2 of the actuator 3. Accordingly, if the actuator 3 moves in the movement direction CD2, the second butting portion 322 collides with the portion P2 (having the maximum height) of the second actuator stopper 4-2, but a collision sound is decreased by the shape of the second actuator stopper 4-2.

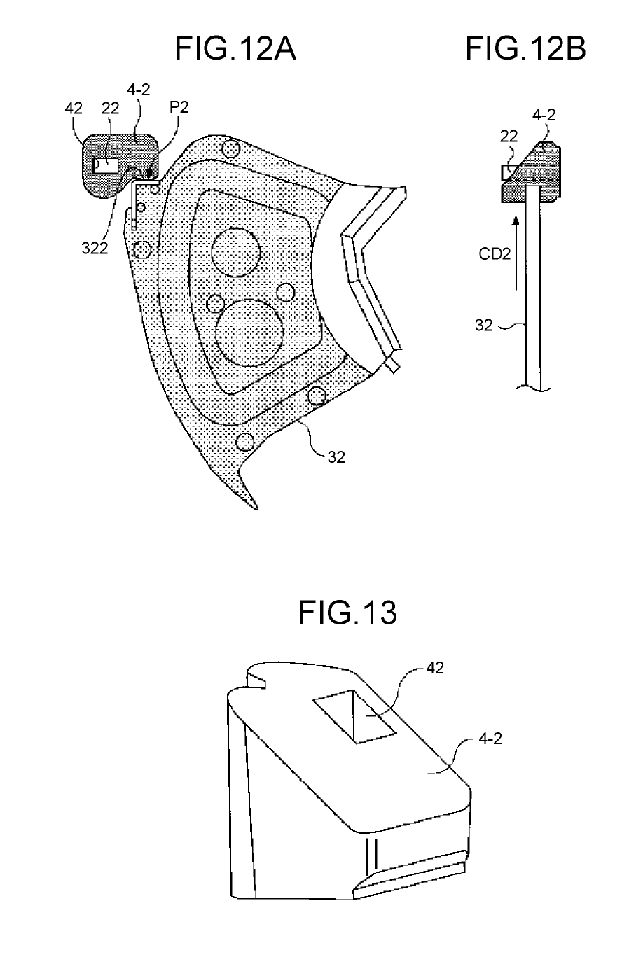

FIGS. 12A and 12B illustrate a second example of the second actuator stopper 4-2. FIGS. 12A and 12B are a plan view and a side view of a state where the second butting portion 322 provided in the molding portion 32 of the actuator 3 contacts the second actuator stopper 4-2, respectively. FIG. 13 is a perspective view of the second example of the second actuator stopper 4-2. In FIGS. 12A to 13, the same components as those in FIGS. 10A to 11 are denoted by the same reference numerals, and the repetitive description is omitted.

As illustrated in FIGS. 12A to 13, the second actuator stopper 4-2 has a cylindrical shape in which a height is maximum at a first portion (or position) P2 contacting the second butting portion 322 and decreases toward a second portion not contacting the second butting portion 322. As can be seen from FIG. 12B, the second actuator stopper 4-2 has an upper taper whose height linearly decreases to a predetermined height larger than zero along a movement direction (clockwise direction in FIGS. 1 to 3) CD2 of the actuator 3. Accordingly, if the actuator 3 moves in the movement direction CD2, the second butting portion 322 collides with the portion P2 (having the maximum height) of the second actuator stopper 4-2, but a collision sound is decreased by the shape of the second actuator stopper 4-2.

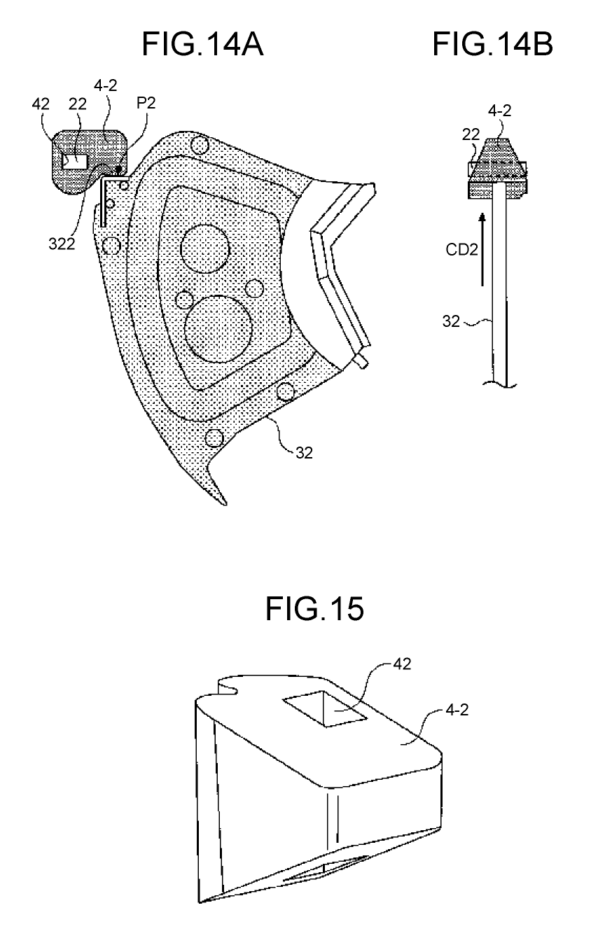

FIGS. 14A and 14B illustrate a third example of the second actuator stopper 4-2. FIGS. 14A and 14B are a plan view and a side view of a state where the second butting portion 322 provided in the molding portion 32 of the actuator 3 contacts the second actuator stopper 4-2, respectively. FIG. 15 is a perspective view of the third example of the second actuator stopper 4-2.

As illustrated in FIGS. 14A to 15, the second actuator stopper 4-2 has a cylindrical shape in which a height is maximum at a first portion (or position) P2 contacting the second butting portion 322 and decreases toward a second portion not contacting the second butting portion 322. As can be seen from FIG. 14B, the second actuator stopper 4-2 has upper and lower tapers whose heights linearly decrease along a movement direction (clockwise direction in FIGS. 1 to 3) CD2 of the actuator 3. The height of the second actuator stopper 4-2 may decrease to approximately zero along the movement direction CD2 or decrease to a predetermined height larger than zero. FIGS. 14A to 15 illustrate the case of the latter. Accordingly, if the actuator 3 moves in the movement direction CD2, the second butting portion 322 collides with the portion P2 (having the maximum height) of the second actuator stopper 4-2, but a collision sound is decreased by the shape of the second actuator stopper 4-2.

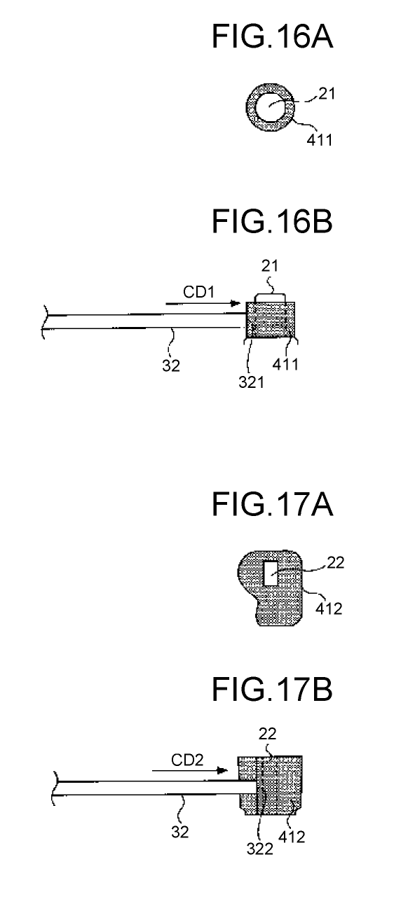

FIGS. 16A and 16B illustrate a comparative example of the first actuator stopper. FIG. 16A is a plan view of a comparative example 411 of the first actuator stopper. FIG. 16B is a side view of a state where the first butting portion 321 provided in the molding portion 32 of the actuator 3 contacts the comparative example 411 of the first actuator stopper. The comparative example 411 of the first actuator stopper is formed of the same material as the first actuator stopper 4-1, and has a cylindrical shape whose height is constant.

FIGS. 17A and 17B illustrate a comparative example of the second actuator stopper. FIG. 17A is a plan view of a comparative example 412 of the second actuator stopper. FIG. 17B is a side view of a state where the second butting portion 322 provided in the molding portion 32 of the actuator 3 contacts the comparative example 412 of the second actuator stopper. The comparative example 412 of the second actuator stopper is formed of the same material as the second actuator stopper 4-2, and has an approximately cylindrical shape whose height is constant.

For convenience of explanation, a horizontal sectional shape (see FIG. 16A) of the comparative example 411 of the first actuator stopper is the same as that in the first example of the first actuator stopper 4-1, and a horizontal sectional shape (see FIG. 17A) of the comparative example 412 of the second actuator stopper is the same as that in the first example of the second actuator stopper 4-2.

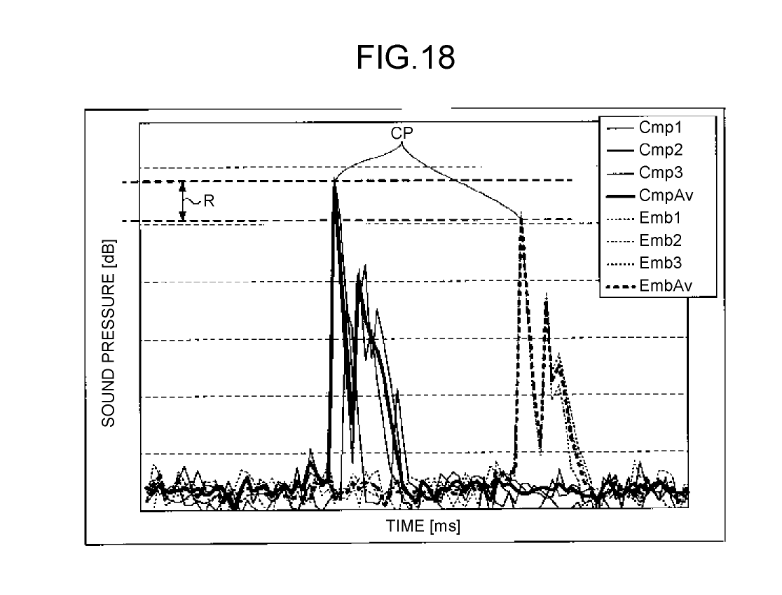

FIG. 18 illustrates collision sounds by the actuator stopper according to the embodiment and the actuator stopper according to the comparative example. In FIG. 18, a vertical axis indicates a sound pressure [dB], a horizontal axis indicates a time [ms], a CP indicates a point of time when the first butting portion 321 of the actuator 3 collides with the first actuator stopper 4-1 illustrated in FIG. 7 and the comparative example 411 of the first actuator stopper illustrated in FIGS. 16A and 16B. Further, Cmp1, Cmp2, and Cmp3 indicate measurement data obtained by using the comparative example 411 illustrated in FIGS. 16A and 16B at different point of times, respectively, and CmpAv indicates an average value of the data Cmp1, Cmp2, and Cmp3. Emb1, Emb2, and Emb3 indicate measurement data obtained by using the first actuator stopper 4-1 illustrated in FIG. 7 at different point of times, respectively, and EmbAv indicates an average value of the data Emb1, Emb2, and Emb3.

When a peak value of the average value CmpAv of the comparative example 411 at the point of time CP is compared with a peak value of the average value EmbAv of the first actuator stopper 4-1 illustrated in FIG. 7, a sound pressure difference R is confirmed. Based on the sound pressure difference R, the increase in the sound pressure caused by the collision from the sound pressure in a normal operation state is compared. It is confirmed that a collision sound is decreased by about 12% in the case of using the first actuator stopper 4-1 illustrated in FIG. 7, with respect to a collision sound generated in the case of using the comparative example 411. In addition, from the measurement result obtained by using the first actuator stopper 4-1 illustrated in FIGS. 5 and 9, it is confirmed that a collision sound is decreased by 12% with respect to the case of using the comparative example 411. In other words, it is confirmed that, when a noise value (base line) in the normal operation state is subtracted from the peak value of the collision sound and the resulting value is compared, a collision sound is decreased by about 12% in the case of using the first actuator stopper 4-1, with respect to the case of using the comparative example 411.

The same measurement as that illustrated in FIG. 18 is performed using the comparative example 412 of the second actuator stopper illustrated in FIGS. 17A and 17B and the second actuator stopper 4-2 illustrated in FIGS. 11, 13, and 15. It is confirmed that a collision sound is decreased by about 12% in the case of using the second actuator stopper 4-2 illustrated in FIGS. 11, 13, and 15, with respect to the collision sound generated in the case of using the comparative example 412.

In the above-described embodiment, the first and second actuator stoppers 4-1 and 4-2 can be formed of the same material as that in the conventional example or the comparative examples 411 and 412. Therefore, a noise that is generated due to a collision between the actuator 3 and each of the first and second actuator stoppers 4-1 and 4-2 can be decreased without changing a design of the existing magnetic disk apparatus, such as a component arrangement, and increasing a cost of the magnetic disk apparatus.

In the above-described embodiment, the first actuator stopper 4-1 may have another hollow quadratic prism shape comprising the shape of the second actuator stopper 4-2. Similarly, the second actuator stopper 4-2 may have another hollow quadratic prism shape comprising the shape of the first actuator stopper 4-1. The first and second actuator stoppers 4-1 and 4-2 may be arbitrarily selected according to the component arrangement of the magnetic disk apparatus 1, as long as the first and second actuator stoppers 4-1 and 4-2 have shapes in which heights are maximum at the first portions (positions) P1 and P2 contacting the first and second butting portions 321 and 322 of the actuator 3, and decrease toward the second portions not contacting the first and second butting portions 321 and 322. That is, the first portion of the first actuator stopper 4-1 may be positioned at the upstream side along the movement direction CD1 of the actuator 3, and the second portion integrated with the first portion may be positioned at the downstream side along the movement direction CD1. Similarly, the first portion of the second actuator stopper 4-2 may be located on the upstream side along the movement direction CD2 of the actuator 3, and the second portion may be located on the downstream side along the movement direction CD2.

In the above-described embodiment, the pin 21 penetrates the first actuator stopper 4-1 and the upper portion of the pin 21 is exposed. However, the pin 21 does not need to penetrate the first actuator stopper 4-1, and the upper portion of the first actuator stopper 4-1 may cover the upper portion of the pin 21. Similarly, the pin 22 penetrates the second actuator stopper 4-2 and the upper portion of the pin 22 is exposed. However, the pin 22 does not need to penetrate the second actuator stopper 4-2, and the upper portion of the second actuator stopper 4-2 may cover the upper portion of the pin 22.

Depending on the movement speed of the actuator 3 colliding with the first and second actuator stoppers 4-1, 4-2, for example, only one actuator stopper, for which the decrease in collision sound is particularly desirable, may be formed in the shape of the above-described embodiment.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An actuator stopper that contacts a butting portion of an actuator which moves a head in a movement direction in a movement plane, and restricts a movement range of the actuator along the movement direction, the actuator stopper comprising:
a first portion configured to be positioned at an upstream side along the movement direction and contact the butting portion of the actuator; and
a second portion configured to be positioned at a downstream side along the movement direction, have a smaller height than the first portion along a direction vertical to the movement plane, and be formed integrally with the first portion.

2. The actuator stopper of claim 1, wherein the first and second portions form a single member that has an inclined surface in at least one of upper and lower portions of a tubular or columnar member.

3. The actuator stopper of claim 2, wherein the single member has an opening, and a pin on a base where the actuator is provided is inserted into the opening to fix the single member.

4. A storage apparatus, comprising:
a head configured to record information on or read information from a storage medium;
an actuator configured to hold and move the head in a movement direction in a movement plane; and
an actuator stopper configured to contact a butting portion of the actuator and restrict a movement range of the actuator along the movement direction;
wherein the actuator stopper comprises
a first portion configured to be positioned at an upstream side along the movement direction and contact the butting portion of the actuator; and
a second portion configured to be positioned at a downstream side along the movement direction, have a smaller height than the first portion along a direction vertical to the movement plane, and be formed integrally with the first portion.

5. The storage apparatus of claim 4, wherein the first and second portions form a single member that has an inclined surface in at least one of upper and lower portions of a tubular or columnar member.

6. The storage apparatus of claim 5, further comprising:
a base configured to allow rotation of the actuator,
wherein the single member has an opening, and a pin on the base is inserted into the opening to fix the single member.

7. The storage apparatus of claim 6, wherein the actuator stopper comprises:
a first actuator stopper configured to restrict a movement range of the actuator in a counterclockwise direction; and
a second actuator stopper configured to restrict a movement range of the actuator in a clockwise direction.

8. The storage apparatus of claim 7, wherein the first and second actuator stoppers have different sectional shapes.

9. The storage apparatus of claim 5, wherein the single member is formed of a material having flexibility.
